(19) United States
(12) Patent Application Publication
(10) Pub. No.: US 2022/0147032 A1
(43) Pub. Date: May 12, 2022

(54) MONITORING METHOD, MONITORING APPARATUS, AND PROGRAM

(71) Applicant: NEC Corporation, Minato-ku, Tokyo (JP)

(72) Inventor: Kiyoshi KATO, Tokyo (JP)

(73) Assignee: NEC Corporation, Minato-ku, Tokyo (JP)

(21) Appl. No.: 17/437,740

(22) PCT Filed: Feb. 26, 2020
(86) PCT No.: PCT/JP2020/007821

§ 371 Date: Sep. 9, 2021

(30) Foreign Application Priority Data
Mar. 19, 2019 (JP) 2019-051170

(51) Int. Cl. G05B 23/02

(52) U.S. Cl. CPC G05B 23/0213

(57) ABSTRACT

A monitoring apparatus according to the present invention includes: a detecting unit configured to detect that a monitored object is in a preset specific state based on a plurality of measured values measured from the monitored object; and a specifying unit configured to specify, among elements causing the measured values, the element related to detection of the specific state of the monitored object based on the measured values, and also specify the element based on preset properties of the elements of the measured values.

### TECHNICAL FIELD

The present invention relates to a monitoring method, a monitoring apparatus, and a program.

### BACKGROUND ART

In a plant such as a manufacturing factory or a processing facility, time-series data composed of observed values of elements that can be measured from various types of sensors is analyzed, and a change in the state of the plant such as occurrence of an anomalous state or occurrence of change in a manufacturing condition is detected. The measured values of the respective elements measured in the plant are, for example, temperature, pressure, flow rate, power consumption value, supply amount of raw material, remaining amount, and so on. As a method for detecting a change in the state of the plant, there is a method of previously generating a model representing a correlation of a plurality of time-series data, checking whether or not newly observed time-series data keeps the correlation represented by the model and, when the correlation represented by the model is not kept, detecting occurrence of an anomalous state. There is also a method of detecting occurrence of a certain state change simply when the time-series data does not satisfy a preset value condition.

A monitored object to detect the abovementioned state change is not limited to a plant, but may be equipment such as an information processing system. For example, in a case where the monitored object is an information processing system, the CPU (Central Processing Unit) usage rate, memory usage rate, disk access frequency, number of input/output packets, power consumption value, and so on, of information processing apparatuses configuring the information processing system are measured as the measured values of the respective elements, and these measured values are analyzed to detect a change in the state of the information processing system.

Then, when a change in the state of the monitored object is detected as described above, there may be a need to specify the cause of the change in the state and properly handle. For example, Patent Document 1 describes grouping and analyzing time-series data that are in an analogous relation and thereby specifying causal time-series data, that is, element.
Patent Document 1: WO2018/096683

However, there arises a problem that even if an element that is the cause of a change in the state of a monitored object is specified as described above, it cannot be properly handled when the element cannot be controlled.

### SUMMARY

Accordingly, an object of the present invention is to provide a monitoring method, a monitoring apparatus and a program that can solve the problem that proper handling cannot be done for a monitored object.

A monitoring method according to an aspect of the present invention includes:

detecting that a monitored object is in a preset specific state based on a plurality of measured values measured from the monitored object;

specifying, among elements causing the measured values, the element related to detection of the specific state of the monitored object based on the measured values; and also

specifying the element based on preset properties of the elements of the measured values.

Further, a monitoring apparatus according to an aspect of the present invention includes: a detecting unit configured to detect that a monitored object is in a preset specific state based on a plurality of measured values measured from the monitored object; and a specifying unit configured to specify, among elements causing the measured values, the element related to detection of the specific state of the monitored object based on the measured values, and also specify the element based on preset properties of the elements of the measured values.

Further, a program according to an aspect of the present invention includes instructions for causing an information processing apparatus to realize: a detecting unit configured to detect that a monitored object is in a preset specific state based on a plurality of measured values measured from the monitored object; and a specifying unit configured to specify, among elements causing the measured values, the element related to detection of the specific state of the monitored object based on the measured values, and also specify the element based on preset properties of the elements of the measured values.

With the configurations as described above, the present invention enables proper handling of a monitored object.

### BRIEF DESCRIPTION OF DRAWINGS

FIG. 1 is a block diagram showing a configuration of a monitoring apparatus in a first example embodiment of the present invention;

FIG. 2 is a view showing a state of processing by the monitoring apparatus disclosed in FIG. 1;

FIG. 3 is a view showing a state of processing by the monitoring apparatus disclosed in FIG. 1;

FIG. 4 is a view showing a state of processing by the monitoring apparatus disclosed in FIG. 1;

FIG. 5 is a flowchart showing an operation of the monitoring apparatus disclosed in FIG. 1;

FIG. 6 is a flowchart showing an operation of the monitoring apparatus disclosed in FIG. 1;

FIG. 7 is a view showing a state of processing by a monitoring apparatus in a second example embodiment of the present invention;

FIG. 8 is a view showing a state of processing by the monitoring apparatus in the second example embodiment;

FIG. 9 is a view showing a state of processing by the monitoring apparatus in the second example embodiment;

FIG. 10 is a flowchart showing an operation of the monitoring apparatus in the second example embodiment;

FIG. 11 is a block diagram showing a hardware configuration of a monitoring apparatus in a third example embodiment of the present invention;

FIG. 12 is a block diagram showing a configuration of the monitoring apparatus in the third example embodiment of the present invention; and

FIG. 13 is a flowchart showing an operation of the monitoring apparatus in the third example embodiment of the present invention.

### EXAMPLE EMBODIMENTS

### First Example Embodiment

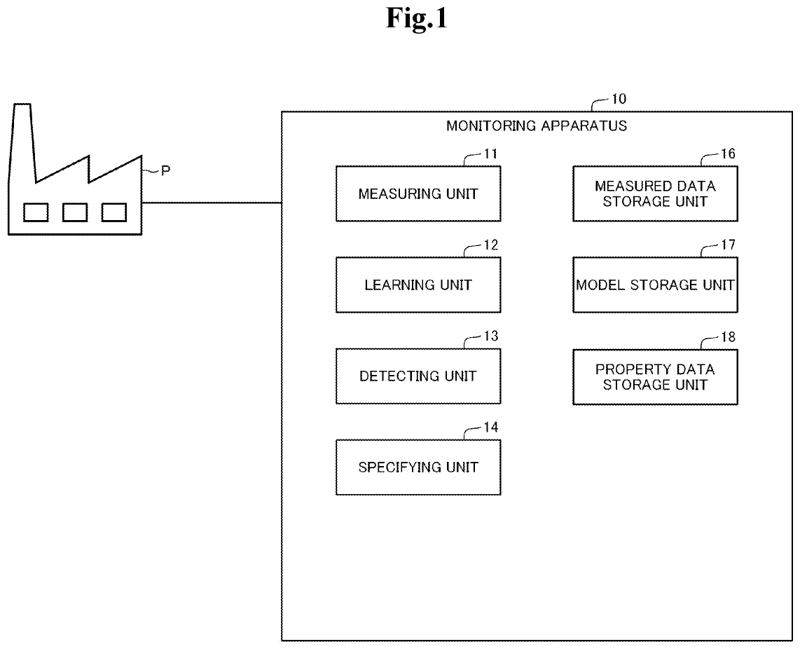

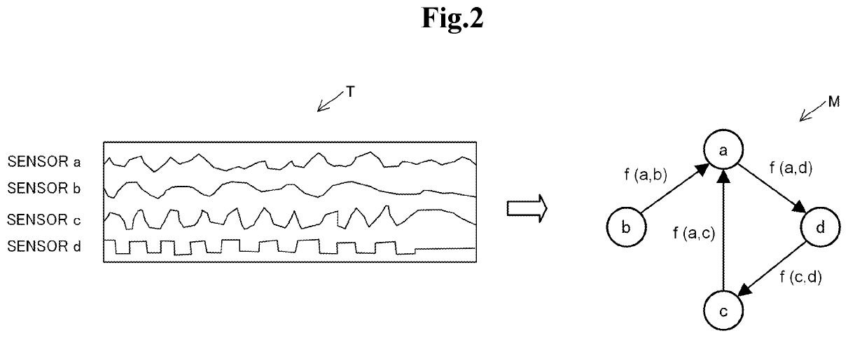

A first example embodiment of the present invention will be described with reference to FIGS. 1 to 6. FIG. 1 is a view for describing a configuration of a monitoring apparatus, and FIGS. 2 to 6 are views for describing a processing operation of the monitoring apparatus.

### [Configuration]

A monitoring apparatus 10 according to the present invention is connected to a monitored object P (an object) such as a plant. The monitoring apparatus 10 is used for acquisition and analysis of measured values of elements of the monitored object P and for monitoring of the state of the monitored object P based on the result of the analysis. For example, the monitored object P is a plant such as a manufacturing factory or a processing facility, and the measured values of the respective elements includes a plurality of kinds of information such as temperature, pressure, flow rate, power consumption value, raw material supply amount, and remaining amount in the plant. In this example embodiment, the state of the monitored object P to be monitored is an anomalous state of the monitored object P, and as will be described later, the monitoring apparatus 10 performs a process to calculate the degree of anomaly from the measured values using a correlation model representing a correlation of the elements and detect and notify the anomalous state from the degree of anomaly. Moreover, the monitoring apparatus 10 according to the present invention specifies the cause of the anomalous state, and also specifies an object to be controlled in order to handle the anomalous state.

However, the monitored object P in the present invention is not limited to a plant, and may be a facility such as an information processing system, and the like. For example, in a case where the monitored object P is an information processing system, the monitoring apparatus 10 may measure the CPU (Central Processing Unit) usage rate, memory usage rate, disk access frequency, number of input/output packets, power consumption value, and so on, of an information processing apparatus configuring the information processing system, as the measured values of the respective elements, analyze the measured values to monitor the state of the information processing system, specifies the cause of the anomalous state, and also specifies an object to be controlled in order to handle the anomalous state.

The monitoring apparatus 10 includes one or a plurality of information processing apparatuses each including an arithmetic logic unit and a storage unit. As shown in FIG. 1, the monitoring apparatus 10 includes a measuring unit 11, a learning unit 12, a detecting unit 13, and a specifying unit 14, which are structured by execution of a program by the arithmetic logic unit. Moreover, the monitoring apparatus 10 includes a measured data storage unit 16, a model storage unit 17, and a property data storage unit 18, which are formed in the storage unit. The respective components will be described in detail below

The measuring unit 11 acquires measured values of elements measured by various types of sensors a, b, c, and d installed in the monitored object P as time-series data at given time intervals, and stores the times-series data into the measured data storage unit 16. Since there are a plurality of kinds of elements to be measured, the measuring unit 11 acquires a time-series data set that is a set of time-series data of the plurality of elements as denoted by reference symbol T in FIG. 2. The acquisition and storage of the time-series data set by the measuring unit 11 is performed at all times, and as will be described later, the acquired time-series data set is used at the time of generating a correlation model representing a normal state of the monitored object P and at the time of monitoring the state of the monitored object P, respectively.

In this example embodiment, a measured value by one sensor is a value obtained by measuring a state arising from one element. For example, in a case where a measured value by a “sensor” is “temperature”, an “element” is a measured value obtained by measuring “temperature in a plant”. Meanwhile, in a second example embodiment to be described later, a measured value by one sensor is a value obtained by measuring a state arising from a plurality of generation sources (elements). For example, in a case where a measured value by a “sensor” is “frequency”, the “frequency” is a value obtained by measuring “frequency” from a “frequency component of vibrations of a machine that is a generation source” and a “frequency component of vibrations due to an earthquake that is a generation source”.

The learning unit 12 inputs a time-series data set T measured when the monitored object P is determined to be in a normal state in advance and generates a correlation model M representing a correlation between elements in the normal state as shown in FIG. 2. For example, the correlation model includes a correlation function that represents a correlation between measured values of any two elements among a plurality of elements. The correlation function is a function that predicts an output value of one element of any two elements with respect to an input value of the other element. At this time, a weight is set in each of the correlation functions between the elements included in the correlation model. The learning unit 12 generates a set of a plurality of correlation functions between elements as described above as the correlation model M, and stores the correlation model M into the model storage unit 17. As an example, the correlation model M shown in FIG. 2 shows that the measured value of an element a and the measured value of an element b have a correlation of a correlation function f(a, b), whereas the measured value of the element b and the measured value of an element c do not have a correlation.

The detecting unit 13 acquires a time-series data set T measured after the abovementioned correlation model M is generated, analyzes the time-series data set T, and detects the anomalous state of the monitored object P. To be specific, the detecting unit 13 inputs a time-series data set T measured from the monitored object P, and calculates the degree of anomaly (information representing an anomalous state) representing a degree to which the monitored object P is in the anomalous state, using the correlation model M stored in the model storage unit 17. At this time, for example, the detecting unit 13 inputs a measured value of one of given two elements as an input value into a correlation function between the two elements, predicts an output value of the other of the two elements, and checks a difference between the predicted value and an actually measured value. When the difference is equal to or more than a predetermined value, the detecting unit 13 detects a correlation breakdown in the correlation between the two elements. Then, the detecting unit 13 checks the differences in the plurality of correlation functions between the elements and the status of correlation breakdown, and calculates the degree of anomaly according to the magnitude of the difference, the weight in the correlation function, the number of correlation breakdowns, and so on. For example, as the degree of correlation breakdown is higher, the detecting unit 13 calculates the value of the degree of anomaly to be higher, regarding the degree of the anomalous state of the monitored object P as higher. Then, the detecting unit 13 calculates the degree of anomaly with respect to each time of the time-series data set, and detects the monitored object P is in the anomalous state when the degree of anomaly is equal to or more than a threshold value. At this time, when the anomaly state of the monitored object P continues, the detecting unit 13 regards a period in which the state continues as an anomaly period, and when the degree of anomaly becomes equal to or less than a threshold value, the detecting unit 13 detects the end of the anomalous state and records a period up to that time as an anomaly period. However, a method for detecting an anomalous state by the detecting unit 13 is not limited to the abovementioned method, and may be any method.

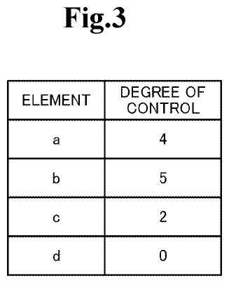

The specifying unit 14 specifies elements corresponding to measured values included in a time-series data set T measured from the monitored object P in the anomalous state, from the time-series data set T. At this time, the specifying unit 14 ranks and specifies the elements based on property data representing properties of elements stored in the property data storage unit 18. The property data is, for example, as shown in FIG. 3, a degree of control that indicates the degree of controllability of each of the elements measured by the respective sensors. The degree of control represents that it is easier to control as its numerical value is larger. For example, the element d has a degree of control of “0”, representing that it cannot be controlled like the temperature and humidity of the air. The element b has a degree of control of “5”, which is a higher value than the others, representing that an operator can easily change the setting and easily control. The degree of control is not limited to the abovementioned value, and may be a value representing whether or not it is controllable. For example, by distinguishing the temperature of the outside air that is difficult to control, the temperature of a pipe that can be controlled by construction, and the temperature of a pipe that can be easily controlled, by an installed heater may be distinguished by binary or multi-valued numerical values, degrees of control may be expressed.

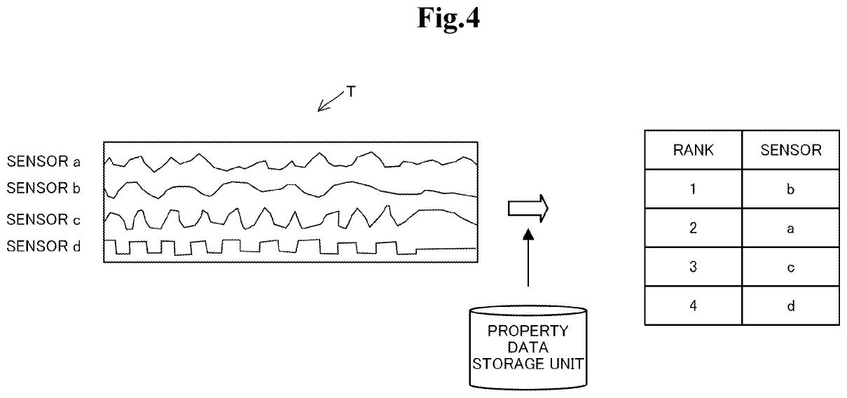

Then, as shown in FIG. 4, the specifying unit 14 ranks the elements corresponding to the measured values included in the time-series data set T measured from the monitored object P in the anomalous state in order of remarkableness of the difference between the measured value in the abovementioned anomaly period and the measured value in the remaining period, and also ranks the elements so as to be highly ranked in descending order of the degree of control based on the degrees of control of the property data. The reason for ranking the elements in order of remarkableness of the difference between the measured value in the anomaly period and the measured value in the remaining period (in descending order of the magnitude of the difference) is to specify and rank elements related to the occurrence of the anomalous state, that is, elements that are the cause of the occurrence of the anomalous state or in the causal relation. Then, in consideration of the ranking, and further based on the degrees of control of the property data, the specifying unit 14 ranks the elements. The elements that are the cause of the occurrence of the abnormal state or the elements that are in the causal relation do not necessarily need to be ranked, and such elements may be simply extracted. Then, the extracted elements are ranked based on the degrees of control of the property data. For example, in the example of FIG. 4, the specifying unit 14 extracts all the elements corresponding to the measured values included in all the time-series data sets T as the elements related to the occurrence of the anomalous state, and ranks all the elements. However, the specifying unit 14 does not necessarily need to rank all the elements, and may rank only a given number of elements from the top, or may rank excluding an element that has a degree of control equal to or less than a given value, or may specify only the highest one element. Then, the specifying unit 14 specifies the ranked elements as elements that are easy to control and outputs them to a monitoring person or the like.

Meanwhile, the specifying unit 14 is not necessarily limited to ranking and specifying elements by the abovementioned method. For example, the specifying unit 14 is not necessarily limited to ranking elements based on degrees of control, and may rank and specify elements using property data representing another property of the elements. As an example, the property data may be the degree of necessity of elements in the monitored object P, the degree of influence of elements on the monitored object P, or the like.

### [Operation]

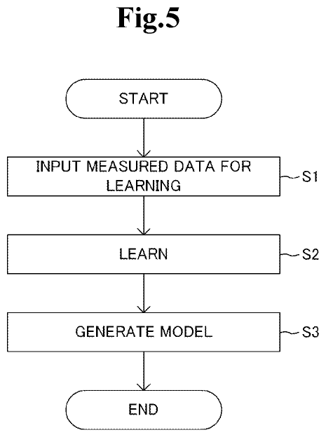

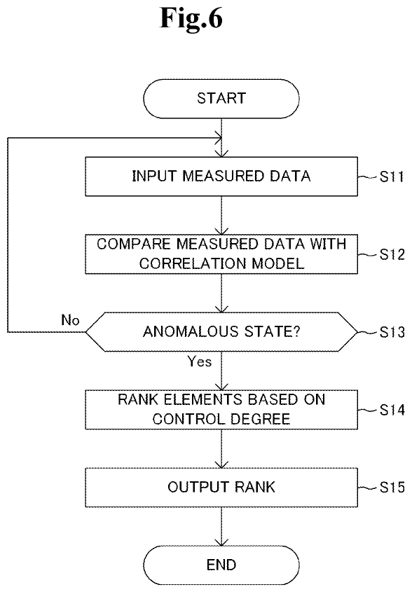

Next, an operation of the above monitoring apparatus 10 will be described majorly with reference to flowcharts of FIGS. 5 to 6. First, with reference to the flowchart of FIG. 5, an operation when generating a correlation model representing a correlation between elements in a state where the monitored object P is in the normal state will be described.

The monitoring apparatus 10 first retrieves and inputs data for learning, which is a time-series data set measured when the monitored object P is determined to be in the normal state, from the measured data storage unit 16 (step S1). Then, the monitoring apparatus 10 learns a correlation between elements from the input time-series data (step S2), and generates a correlation model representing the correlation between the elements (step S3). Then, the monitoring apparatus 10 stores the generated correlation model as a correlation model representing the normal state of the monitored object P into the model storage unit 17.

Next, with reference to the flowchart of FIG. 6, an operation when detecting the anomalous state of the monitored object P will be described. The monitoring apparatus 10 acquires a specific measured value measured from the monitored object P (step S11), compares with the correlation model M (step S12), and checks whether or not a correlation breakdown occurs based on the difference from the correlation model M, and moreover, calculates the degree of anomaly to check whether to be the anomalous state (step S13).

When detecting that the monitored object P is in the anomalous state (step S13, Yes), the monitoring apparatus 10 ranks and extracts elements related to the occurrence of the anomalous state among elements corresponding to measured values included in the time-series data set T measured from the monitored object P in the anomalous state, and further ranks and specifies the extracted elements based on property data (step S14). Then, the monitoring apparatus 10 output the ranked elements to a monitoring person or the like (step S15).

As described above, in this example embodiment, by first specifying the elements related to the occurrence of the anomalous state among the elements corresponding to the measured values included in the time-series data set when the monitored object is in the anomalous state, the elements to be controlled can be easily specified. Then, in this example embodiment, the elements are further ranked according to the degree of control that is the property of elements. Therefore, based on the result of ranking the elements according to ease of control, it is possible to perform control such as change of the setting of the element in a higher rank, and it is possible to proper handle the anomalous state.

Although elements when the monitored object P is in the anomalous state are specified by ranking or the like in the above description, elements when the monitored object P falls in any specific state may be specified, not necessarily limited to those when the monitored object P is in the anomalous state. Detection of the specific state of the monitored object P is not limited to using the abovementioned correlation model M, and may be performed by any method.

### Second Example Embodiment

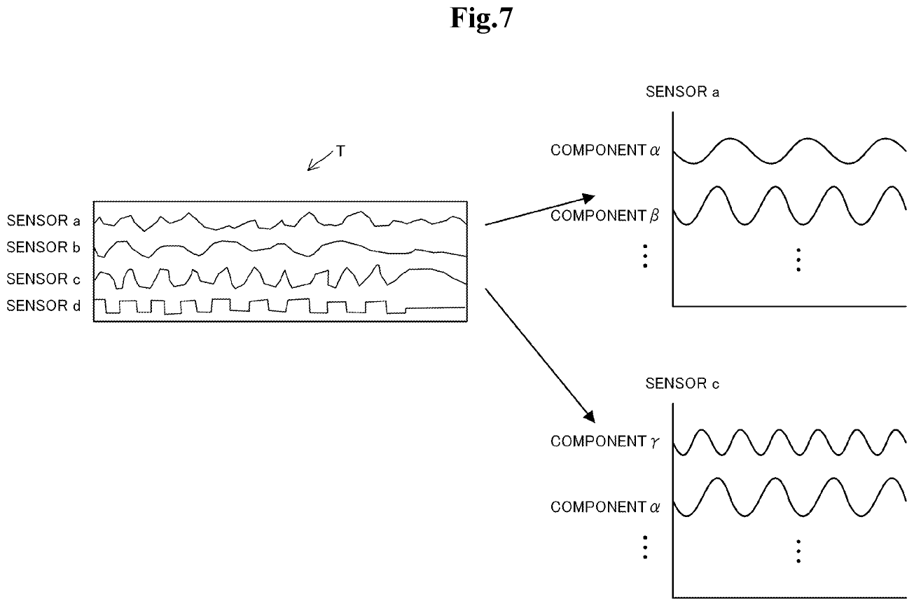

Next, a second example embodiment of the present invention will be described with reference to FIGS. 7 to 10. FIGS. 7 to 10 are views for describing a processing operation of a monitoring apparatus. A monitoring apparatus 10 in this example embodiment further includes the following configuration, in addition to the configuration of the monitoring apparatus 10 described in the first example embodiment. Below, the configuration different from that of the first example embodiment will be majorly described.

### [Configuration]

First, in this example embodiment, a measured value which the measuring unit 11 measures from one sensor installed in the monitored object P is a value obtained by measuring a state arising from a plurality of generation sources (elements). For example, in a case where a measured value by a “sensor” is “frequency”, the measured value is a value obtained by measuring “frequency” from a “component of vibrations of a machine that is a generation source” and a “component of vibrations due to an earthquake that is a generation source”.

When the detecting unit 13 detects the anomalous state of the monitored object P from a time-series data set T measured from the monitored object P, the specifying unit 14 in this example embodiment ranks and specifies generation sources (elements) that generate component values causing measured values included by the time-series data set T. To be specific, as shown in FIG. 7, the specifying unit 14 extracts, from each of the measured values measured by the respective sensors a, b, c, and d included by a time-series data set T in the anomalous state, a component value for each generation source causing the measured value. For example, the specifying unit 14 extracts component values α and β from a measured value of the sensor a, and extracts component values γ and α from a measured value of the sensor c. Then, the specifying unit 14 checks the properties of the extracted component values α, β, and γ from these component values, and specifies generation sources of the component values. For example, correspondence information between a frequency characteristic and a vibration source that is a generation source is stored in advance in the monitoring apparatus 10, and the specifying unit 14 specifies a generation source from the frequency characteristic of a component value with reference to the correspondence information. With this, the specifying unit 14 specifies the generation sources of the component values α, β, and γ as generation sources α, β, and γ, respectively.

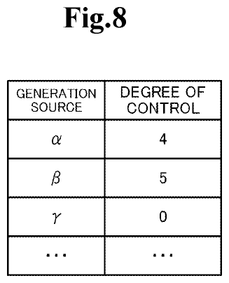

Subsequently, the specifying unit 14 ranks the generation sources α, β, and γ. At this time, in the same manner as described above, the specifying unit 14 may first rank the generation sources in order of the remarkableness of a difference in each of the generation sources in the anomaly period and the remaining period (in order of the magnitude of the difference), or may simply extract. With this, it is possible to specify a generation source related to the occurrence of the anomalous state, that is, a generation source that is the cause of the occurrence of the anomalous state or has a causal relation. Then, in consideration of this ranking, the specifying unit 14 further ranks the generation sources based on property data representing the properties of generation sources stored in the property data storage unit 18. The property data is, for example, as shown in FIG. 8, the degree of control indicating the degree of controllability of each generation source. The degree of control represents that a larger numerical value is easier to control. Therefore, the generation source γ has a degree of control of “0”, representing that it cannot be controlled like vibrations due to an earthquake, and the generation source α has a degree of control of “5”, which is a higher value than the others, representing that it can be easily controlled by an operator like vibrations due to machine equipment. The degree of control is not limited to the abovementioned values, and may be a value simply representing whether or not it is possible to control.

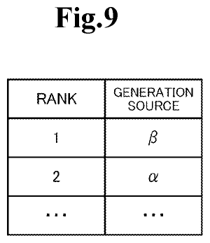

Then, as shown in FIG. 9, the specifying unit 14 ranks the generation sources generating the measured values included by the time-series data set T measured from the monitored object P in the anomalous state based on the degrees of control of the property data so that higher degrees of control are highly ranked. At this time, the specifying unit 14 may rank all the generation sources, or may rank and specify only some of the generation sources. Moreover, the specifying unit 14 may specify a generation source of a component value extracted in common from a plurality of measured values, and may highly rank such a generation source. For example, in the example of FIG. 7, the measured values measured by the sensors a and c include the component value α in common. Therefore, if the generation source α of the component value α is controllable, the specifying unit 14 may specify the generation source α. With this, it is possible to specify a generation source that influences a plurality of measured values of the monitored object P.

The monitoring apparatus 10 in this example embodiment is not necessarily limited to extracting a component value from a measured value and specifying a generation source from the component value by the abovementioned method, but may extract a component value and specify a generation source by any method. Moreover, as in the first example embodiment, the monitoring apparatus 10 in this example embodiment is not necessarily limited to ranking and specifying generation sources by the abovementioned method, and is not necessarily limited to ranking generation sources based on the degrees of control of the generation sources.

### [Operation]

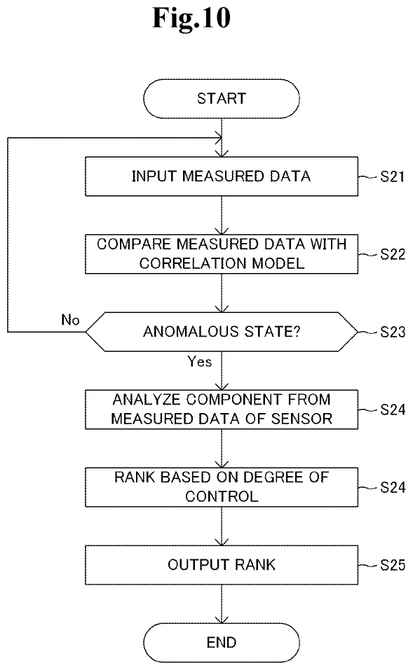

Next, an operation of the monitoring apparatus 10 in this example embodiment will be described majorly with reference to a flowchart shown in FIG. 10. Below, only an operation when detecting the anomalous state of the monitored object P will be described.

The monitoring apparatus 10 acquires a specific measured value measured from the monitored object P (step S21), compares with the correlation model M (step S22), checks whether or not a correlation breakdown is caused based on a difference from the correlation model M, and moreover, calculates the degree of anomaly to check whether or not it is the anomalous state (step S23).

Upon detecting that the monitored object P is in the anomalous state (step S23, Yes), the monitoring apparatus 10 performs the analysis of components of measured values included by a time-series data set T measured from the monitored object P in the anomalous state (step S24). To be specific, the monitoring apparatus 10 extracts component values from the respective measured values and specifies the generation sources of the respective component values. Then, the monitoring apparatus 10 specifies generation sources related to the occurrence of the anomalous state among the specified generation sources, further ranks and specifies the generation sources based on property data such as a degree of control, and outputs to a monitoring person or the like (step S25).

As described above, in this example embodiment, among generation sources (elements) that cause measured values included by a time-series data set when a monitored object falls into an anomalous state, generation sources related to the occurrence of the anomalous state are first specified, so that generation sources to be controlled can be easily specified. Then, the generation sources are ranked according to the degrees of control that are the properties of the generation sources. With this, it is possible to take measures such as specifying and controlling a generation source according to ease of control, and it is possible to properly handle the anomalous state of the monitored object P.

### Third Example Embodiment

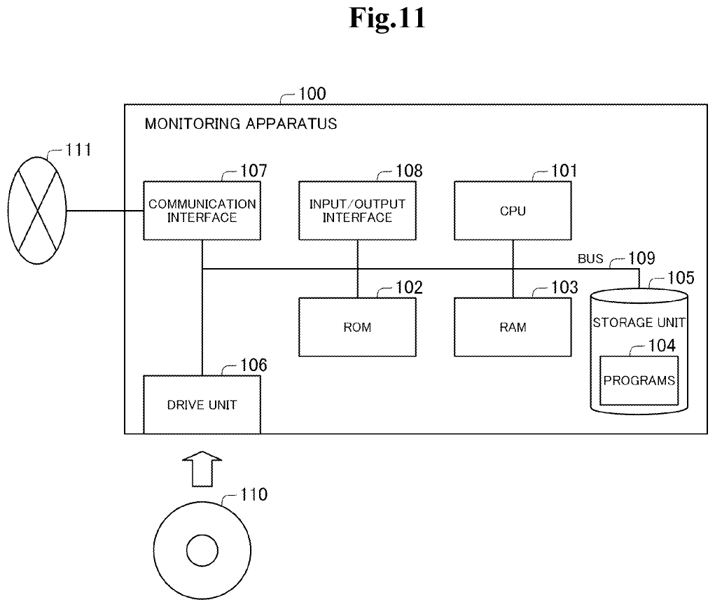

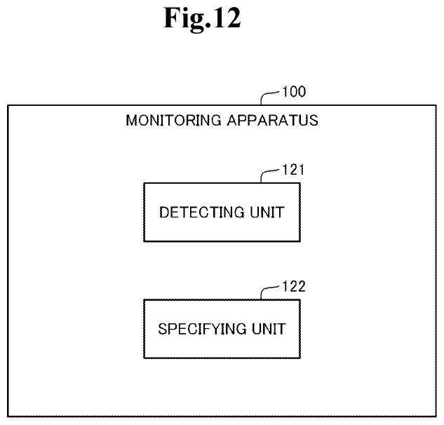

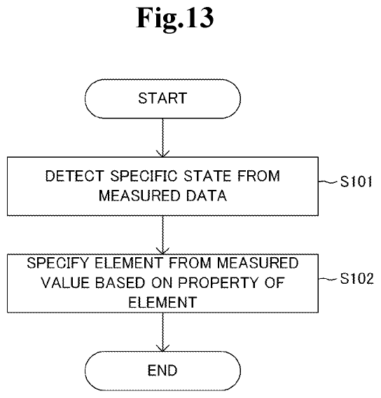

Next, a third example embodiment of the present invention will be described with reference to FIGS. 11 to 13. FIGS. 11 to 12 are block diagrams showing a configuration of a monitoring apparatus in the third example embodiment, and FIG. 13 is a flowchart showing an operation of the monitoring apparatus. In this example embodiment, the overview of the configurations of the monitoring apparatus and the processing method by the monitoring apparatus described in the first example embodiment is illustrated.

First, with reference to FIG. 11, a hardware configuration of a monitoring apparatus 100 in this example embodiment will be described. The monitoring apparatus 100 is configured by a general information processing apparatus, and as an example, includes the following hardware configuration;

a CPU (Central Processing Unit) 101 (an arithmetic logic unit),

a ROM (Read Only Memory) 102 (a storage unit),

a RAM (Random Access Memory) 103 (a storage unit),

programs 104 loaded to the RAM 103,

a storage unit 105 for storing the programs 104,

a drive unit 106 that reads from and writes into a storage medium 110 outside the information processing apparatus,

a communication interface 107 connecting to a communication network 111 outside the information processing apparatus,

an input/output interface 108 performing input/output of data, and

a bus 109 connecting the respective components.

Then, the monitoring apparatus 100 can structure and install a detecting unit 121 and a specifying unit 122 shown in FIG. 12 therein by the CPU 101 acquiring and executing the programs 104. The programs 104 are, for example, previously stored in the storage unit 105 or the ROM 102, and loaded into the RAM 103 and executed by the CPU 101 as necessary. The programs 104 may be supplied to the CPU 101 via the communication network 111, or may be previously stored in the recording unit 110 and retrieved and supplied to the CPU 101 by the drive unit 106. However, the detecting unit 121 and the specifying unit 122 mentioned above may be structured by an electronic circuit.

FIG. 12 shows an example of the hardware configuration of the information processing apparatus that is the monitoring apparatus 100, and the hardware configuration of the information processing apparatus is not illustrated in the abovementioned case. For example, the information processing apparatus may be configured by part of the abovementioned configuration, for example, configured without the drive unit 106.

Then, the monitoring apparatus 100 executes a monitoring method shown in a flowchart of FIG. 13 by the functions of the detecting unit 121 and the specifying unit 122 structured by the program as described above.

As shown in FIG. 13, the monitoring apparatus 100:

based on a plurality of measured values measured from a monitored object, detects that the monitored object is in a specific state set in advance (step S101); and

specifies, among elements causing the plurality of measured values, the elements related to detection of the specific state of the monitored object based on the measured values, and also specifies the elements based on properties of the elements of the measured values set in advance (step 102).

With the configurations as described above, the present invention enables easily specifying an element to be controlled by first specifying elements related to occurrence of an anomalous state among elements causing measured values when a monitored object falls into a specific state. Then, the element to be controlled is specified based on properties of elements. Therefore, it is possible to specify and operate an element, such as an element that is easy to control, corresponding to the properties of the elements, and it is possible to properly handle the monitored object.

The abovementioned program can be stored in various types of non-transitory computer-readable mediums and supplied to a computer. The non-transitory computer-readable mediums include various types of tangible storage mediums. The non-transitory computer-readable mediums include, for example, a magnetic recording medium (for example, a flexible disk, a magnetic tape, a hard disk drive), an optical magnetic recording medium (for example, a magnetooptical disk), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory)). Moreover, the program may be supplied to a computer by various types of transitory computer-readable mediums. The transitory computer-readable mediums include, for example, an electric signal, an optical signal, and an electromagnetic wave. The transitory computer-readable mediums can supply the program to a computer via a wired communication path such as an electric wire and an optical fiber or a wireless communication path.

Although the present invention has been described above with reference to the example embodiments and so on, the present invention is not limited to the above example embodiments. The configurations and details of the present invention can be changed in various manners that can be understood by one skilled in the art within the scope of the present invention.

The present invention is based upon and claims the benefit of priority from Japanese patent application No. 2019-051170, filed on Mar. 19, 2019, the disclosure of which is incorporated herein in its entirety by reference.

### <Supplementary Notes>

The whole or part of the example embodiments disclosed above can be described as the following supplementary notes. Below, the overview of the configurations of a monitoring method, a monitoring apparatus, and a program according to the present invention will be described. However, the present invention is not limited to the following configurations.

### (Supplementary Note 1)

A monitoring method comprising: detecting that a monitored object is in a preset specific state based on a plurality of measured values measured from the monitored object;

specifying, among elements causing the measured values, the element related to detection of the specific state of the monitored object based on the measured values; and also

specifying the element based on preset properties of the elements of the measured values.

### (Supplementary Note 2)

The monitoring method according to Supplementary Note 1, comprising, based on the properties of the elements, ranking the elements and specifying the element.

### (Supplementary Note 3)

The monitoring method according to Supplementary Note 1 or 2, comprising specifying the element based on whether or not the elements can be controlled representing the properties of the elements.

### (Supplementary Note 4)

The monitoring method according to any of Supplementary Notes 1 to 3, comprising, based on degrees of whether or not the elements can be controlled representing the properties of the elements, ranking the elements and specifying the element.

### (Supplementary Note 5)

The monitoring method according to Supplementary Note 4, comprising, as degrees of controllability of the elements representing the properties of the elements are higher, more highly ranking the elements.

### (Supplementary Note 6)

The monitoring method according to any of Supplementary Notes 1 to 5, comprising extracting a component value of each of the elements causing the measured values from the measured values, and specifying the element based on a result of extracting.

### (Supplementary Note 7)

The monitoring method according to Supplementary Note 6, comprising specifying the element included in some of the measured values based on the result of extracting the component value of each of the elements causing the measured values from the measured values.

### (Supplementary Note 8)

A monitoring apparatus comprising:

a detecting unit configured to detect that a monitored object is in a preset specific state based on a plurality of measured values measured from the monitored object; and

a specifying unit configured to specify, among elements causing the measured values, the element related to detection of the specific state of the monitored object based on the measured values, and also specify the element based on preset properties of the elements of the measured values.

### (Supplementary Note 9)

The monitoring apparatus according to Supplementary Note 8, wherein the specifying unit is configured to extract a component value of each of the elements causing the measured values from the measured values, and specify the element based on a result of extracting.

### (Supplementary Note 10)

A program comprising instructions for causing an information processing apparatus to realize:

a detecting unit configured to detect that a monitored object is in a preset specific state based on a plurality of measured values measured from the monitored object; and

a specifying unit configured to specify, among elements causing the measured values, the element related to detection of the specific state of the monitored object based on the measured values, and also specify the element based on preset properties of the elements of the measured values.

### (Supplementary Note 11)

The program according to Supplementary Note 10, wherein the specifying unit is configured to extract a component value of each of the elements causing the measured values from the measured values, and specify the element based on a result of extracting.

### DESCRIPTION OF NUMERALS

10 monitoring apparatus
11 measuring unit
12 learning unit
13 detecting unit
14 specifying unit
16 measured data storage unit
17 model storage unit
18 property data storage unit
P monitored object
100 monitoring apparatus
101 CPU
102 ROM
103 RAM
104 programs
105 storage unit
106 drive unit
107 communication interface
108 input/output interface
109 bus
110 storage medium
111 communication network
121 detecting unit
122 specifying unit

What is claimed is:

1. A monitoring method comprising:
detecting that a monitored object is in a preset specific state based on a plurality of measured values measured from the monitored object;
specifying, among elements causing the measured values, the element related to detection of the specific state of the monitored object based on the measured values; and also
specifying the element based on preset properties of the elements of the measured values.

2. The monitoring method according to claim 1, comprising, based on the properties of the elements, ranking the elements and specifying the element.

3. The monitoring method according to claim 1, comprising specifying the element based on whether or not the elements can be controlled representing the properties of the elements.

4. The monitoring method according to claim 1, comprising, based on degrees of whether or not the elements can be controlled representing the properties of the elements, ranking the elements and specifying the element.

5. The monitoring method according to claim 4, comprising, as degrees of controllability of the elements representing the properties of the elements are higher, more highly ranking the elements.

6. The monitoring method according to claim 1, comprising extracting a component value of each of the elements causing the measured values from the measured values, and specifying the element based on a result of extracting.

7. The monitoring method according to claim 6, comprising specifying the element included in some of the measured values based on the result of extracting the component value of each of the elements causing the measured values from the measured values.

8. A monitoring apparatus comprising:
at least one memory configured to store instructions; and
at least one processor configured to execute instructions to:
detect that a monitored object is in a preset specific state based on a plurality of measured values measured from the monitored object; and
specify, among elements causing the measured values, the element related to detection of the specific state of the monitored object based on the measured values, and also specify the element based on preset properties of the elements of the measured values.

9. The monitoring apparatus according to claim 8, wherein the at least one processor is configured to execute the instructions to: extract a component value of each of the elements causing the measured values from the measured values, and specify the element based on a result of extracting.

10. A non-transitory computer-readable storage medium in which a program is stored, the program comprising instructions for causing an information processing apparatus to execute processes to:
detect that a monitored object is in a preset specific state based on a plurality of measured values measured from the monitored object; and
specify, among elements causing the measured values, the element related to detection of the specific state of the monitored object based on the measured values, and also specify the element based on preset properties of the elements of the measured values.

11. The non-transitory computer-readable storage medium in which the program is stored according to claim 10, the program comprising instructions for causing the information processing apparatus to execute processes to extract a component value of each of the elements causing the measured values from the measured values, and specify the element based on a result of extracting.
